(19) United States
(12) Patent Application Publication
(10) Pub. No.: US 2013/0179121 A1
(43) Pub. Date: Jul. 11, 2013

(54) CALCULATING APPARATUS, MEASURING APPARATUS, ELECTRONIC DEVICE, PROGRAM, RECORDING MEDIUM AND CALCULATING METHOD

(71) Applicant: Takahiro YAMAGUCHI, Saitama (JP)

(72) Inventor: Takahiro YAMAGUCHI, Saitama (JP)

(73) Assignee: ADVANTEST CORPORATION, Tokyo (JP)

(21) Appl. No.: 13/344,620

(22) Filed: Jan. 6, 2012

(30) Foreign Application Priority Data
Jan. 6, 2012 (JP) 2012-000930

(51) Int. Cl. G06F 17/18; G06F 17/10

(52) U.S. Cl. 702/181; 703/2

(57) ABSTRACT

A calculating apparatus for calculating a probability density function representing a probability density of a pre-set random variable, from a cumulative probability distribution function representing a cumulative probability distribution of the random variable, includes: a probability density function calculating section that calculates the probability density of each value of the random variable of the probability density function, based only on a value of the cumulative probability distribution function corresponding to the value of the random variable, from among values of the cumulative probability distribution function corresponding to values of the random variable.

### BACKGROUND

1. Technical Field

The present invention relates to a calculating apparatus, a measuring apparatus, an electronic device, a program, a recording medium, and a calculating method.

2. Related Art

Conventionally, methods are known to measure a histogram exhibiting the appearing frequency of a plurality of variable values arranged at a pre-set bin interval, for the purpose of obtaining the probability density function of a pre-set random variable. However, when the bin interval is short, the variance of the probability function value for each bin in the obtained histogram will become large. On the contrary, when the bin interval of the measurement is long, the obtained histogram will be too much smoothed out, preventing reproduction of the original histogram (see for example Non-Patent Document No. 1.)
Non-Patent Document No. 1: Christopher M. Bishop, Pattern Recognition & Machine Learning, Chapter 2—Probability Distributions.

FIG. 1 shows an exemplary histogram. FIG. 1 shows three histograms which adopt the number of bins of 16, 64, and 256 respectively. Note that as the number of bins becomes large, the bin interval becomes short. As clear from FIG. 1, when the number of bins is small such as 16, the obtained histogram will be too much smoothed out, and the offset (bias error) will be added. On the other hand, when the number of bins is increased, i.e., when the bin interval is made shorter, in an attempt to accurately reproduce the original shape of the histogram, the variance of the measured values in each bin becomes large. Here, note that the square root of the variance corresponds to a standard error.

### SUMMARY

Therefore, it is an object of an aspect of the innovations herein to provide a calculating apparatus, a measuring apparatus, an electronic device, a program, a recording medium, and a calculating method, which are capable of overcoming the above drawbacks accompanying the related art. The above and other objects can be achieved by combinations described in the claims. A first aspect of the innovations may be a calculating apparatus for calculating a probability density function representing a probability density of a pre-set random variable, from a cumulative probability distribution function representing a cumulative probability distribution of the random variable, including: a probability density function calculating section that calculates the probability density of each value of the random variable of the probability density function, based only on a value of the cumulative probability distribution function corresponding to the value of the random variable, from among values of the cumulative probability distribution function corresponding to values of the random variable.

A second aspect of the innovations may be measuring apparatus for measuring a characteristic of a measurement target, including: a measuring section that measures the characteristic of the measurement target; and a calculating apparatus according to the first aspect that calculates a probability density function of a measurement result of the measuring section.

A third aspect of the innovations may be an electronic device for generating a signal, including: a measuring section that measures a cumulative probability distribution function representing a cumulative probability distribution of a pre-set random variable, and a calculating apparatus according to the first aspect that calculates the probability density function based on the cumulative probability distribution function measured by the measuring section.

A fourth aspect of the innovations may be a program to cause a computer to function as a calculating apparatus according to the first aspect.

A fifth aspect of the innovations may be a calculating method for calculating a probability density function representing a probability density of a pre-set random variable, from a cumulative probability distribution function representing a cumulative probability distribution of the random variable, including: calculating the probability density of at least one value of the random variable of the probability density function, based only on a value of the cumulative probability distribution function corresponding to the value of the random variable, from among values of the cumulative probability distribution function corresponding to values of the random variable.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary histogram.

FIG. 2 shows an exemplary configuration of a calculating apparatus 100

FIG. 3 shows an operation of a probability density function calculating section 110.

FIG. 4 shows the theoretical values of a uniformly distributed PDF and the corresponding CDF.

FIG. 5 shows the theoretical values of a PDF having a sine curve distribution and the corresponding CDF.

FIG. 6 shows the theoretical values of a PDF having a Gaussian distribution and the corresponding CDF.

FIG. 7 explains an exemplary operation of the probability density function calculating section 110.

FIG. 8 shows a processing flow S900 of the probability density function calculating section 110, when calculating the output PDF using the positive probability density function.

FIG. 9 shows an exemplary processing flow of S904.

FIG. 10 shows another exemplary processing flow of S904.

FIG. 11 shows a processing flow S1200 of the probability density function calculating section 110, when calculating the output PDF using the negative probability density function.

FIG. 12 shows an exemplary processing flow of S1204.

FIG. 13 shows another exemplary processing flow of S1204.

FIG. 14 shows comparison between the output PDF calculated by the probability density function calculating section 110 and the measured PDF.

FIG. 15 shows a configuration example of a measuring apparatus 1600.

FIG. 16 shows a configuration example of an electronic device 1700.

FIG. 17 shows an exemplary hardware configuration of a computer 1800.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

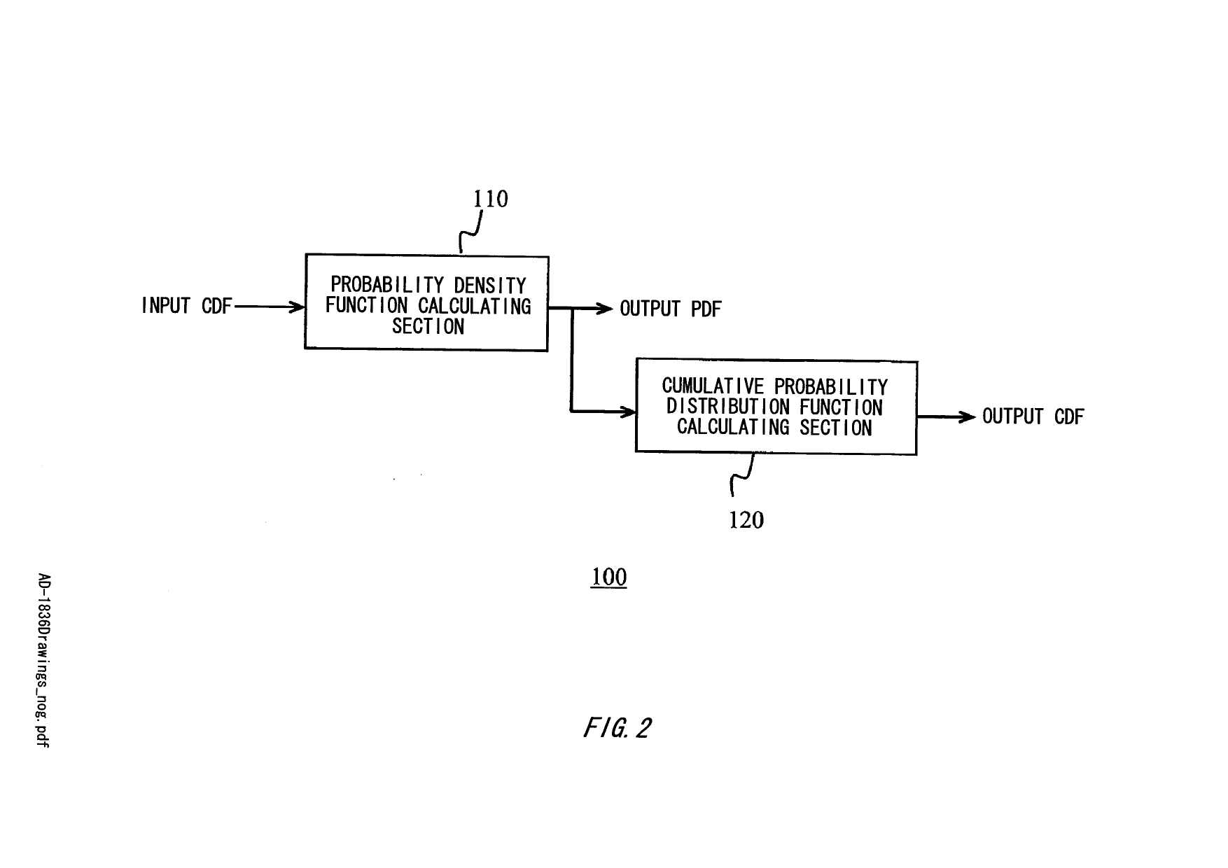

FIG. 2 shows an exemplary configuration of a calculating apparatus 100. The calculating apparatus 100 calculates a probability density function (hereinafter referred to as “output PDF”) representing the probability density of a pre-set random variable, from the cumulative probability distribution function (hereinafter referred to as “input CDF”) representing the cumulative probability distribution of the random variable. The input CDF, adopting the amount of jitter included in the signal, the amplitude value of the signal, or the like as a random variable, represents a cumulative probability distribution of the amount of jitter, the amplitude value, or the like, Here, note that the random variable of the input CDF is not limited to the amount of jitter, the amplitude value. The calculating apparatus 100 can calculate an output CDF for an input CDF related to any random variable.

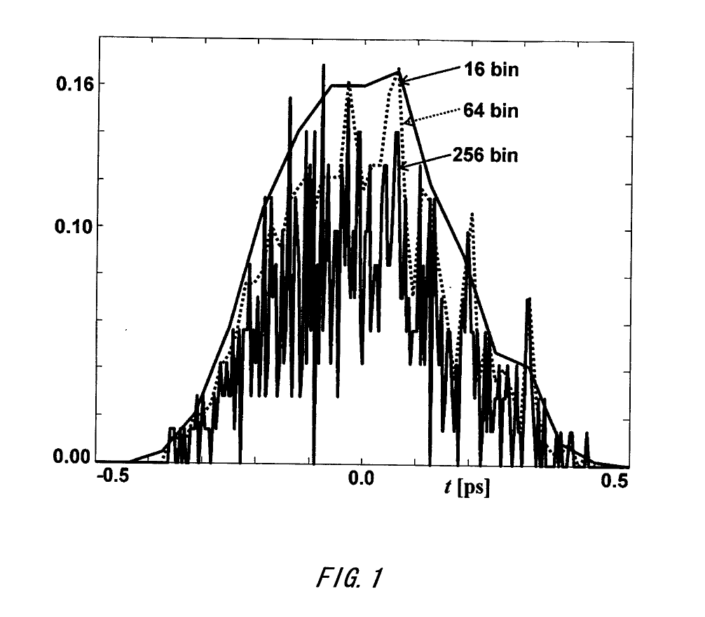

The calculating apparatus 100 includes a probability density function calculating section 110 and a cumulative probability distribution function calculating section 120. The probability density function calculating section 110 receives an input CDF, and outputs an output PDF. The input CDF is generated by measuring the frequency in which a particular phenomenon (e.g., amount of jitter in an electric signal) appears. This frequency corresponds to a probability density function. The input CDF is generated by cumulating the measured values of the probability density function in each bin of a histogram (or a PDF). Here, the histogram of the measured values of a probability density function is referred to as “measured PDF.” Just as the histogram of FIG. 1, this histogram also includes more errors attributed to the variance of the measured values in each bin, as the bin interval gets shorter. Based on the input CDF, the probability density function calculating section 110 generates the output PDF from which the effect of the variance of the measured values in each bin has been excluded.

The cumulative probability distribution function calculating section 120 generates a new output CDF from the output PDF outputted from the probability density function calculating section 110. The cumulative probability distribution function calculating section 120 may generate the output CDF by cumulating the probability density function of each bin of the output PDF. Note that the calculating apparatus 100 may not have to include the cumulative probability distribution function calculating section 120.

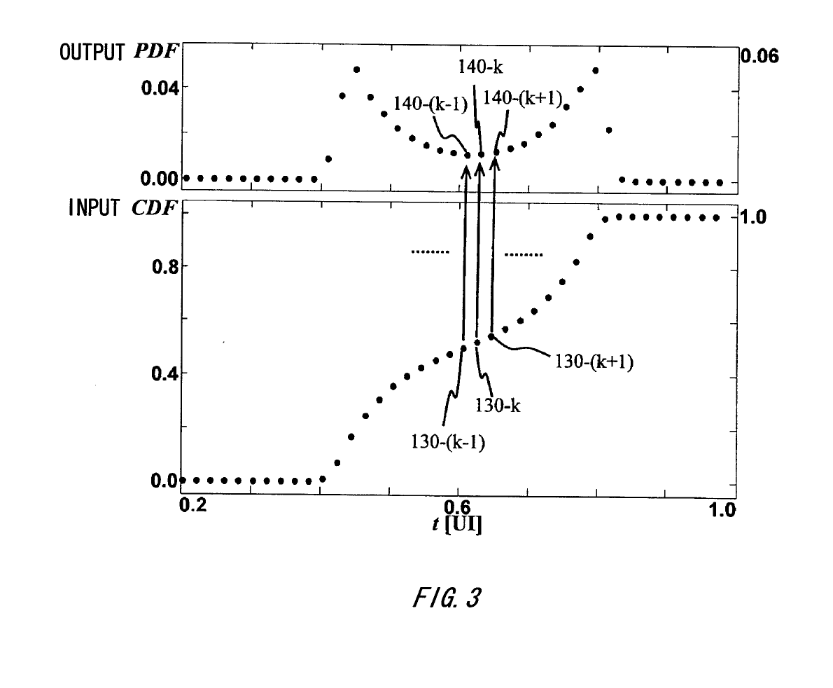

FIG. 3 shows an operation of a probability density function calculating section 110. The upper half of FIG. 3 shows an output PDF, and the lower half shows an input CDF. The plot of round marks in FIG. 3 is used to represent the probability density function or the cumulative probability distribution function (occasionally referred to as “probability distribution function”) for each bin. The random variable (i.e., lateral axis) of the PDF and the CDF shown in FIG. 3 is time. In an example, the random variable of FIG. 3 may be the amount of jitter contained in an electric signal. Note that the amount of jitter is expressed as a ratio of the electric signal to 1UI (unit interval).

The probability density function calculating section 110 calculates the probability density function value 140 for each value of a random variable (i.e. each bin) of the output PDF, based only on the corresponding cumulative probability distribution function value 130 corresponding to this value of the random variable, from among the cumulative probability distribution function values 130 corresponding to the values of the random variable. For example, the probability density function calculating section 110 calculates the probability density function value 140-k for the k-th bin, based only on the cumulative probability distribution function value 130-k for the corresponding bin, from among the cumulative probability distribution function values 130 corresponding to a plurality of bins. In this way, the probability density function value 140 excluding the effect of the variance of the measured value can be calculated for each bin.

Concretely, the probability density function calculating section 110 calculates the probability density function value 140 for each value of a random variable, based on the variance of the cumulative probability distribution function value 130 for the particular value of the random variable. The following explains a method of calculating a probability density function value 140 from the variance of a cumulative probability distribution function value 130.

Generally, the relation between the PDF and the CDF is given by the following expression 1.

$$f ( t ) = \frac{d F ( t )}{d t} = {lim}_{W -> 0} \frac{F ( t + W ) - F ( t )}{W} = {lim}_{W -> 0} \frac{F ( t , W )}{W} \qquad ( Expression 1 )$$

Here, f(t) represents PDF, F(t) represents CDF, t represents a random variable, and W represents a bin interval.

In addition, the variance “Var” [F(t, W)] for the CDF is given by the following expressions 2.1 and 2.2.

$$\begin{matrix}Var [ F ( t , W ) ] = \frac{1}{T} {\int }_{0}^{T} {[ F ( t , W ) - μ ]}^{2} d τ = {W}^{2} Var [ f ( t ) ] & ( Expression 2.1 ) \\ Var [ F ( t , W ) ] = F ( t , W ) [ 1 - F ( t , W ) ] / N & ( Expression 2.2 )\end{matrix}$$

Note that N represents the total number of bins in the CDF.

The variance “Var” [F(t, W)] can be calculated as follows. When the random variable t takes the value of k, the probability p can be calculated using the cumulative probability distribution function F(k, w).

$$p = \frac{F ( k , W )}{\sum F ( k , W )}$$

Next, the probability “q” is calculated as follows.

q=1−p

Finally, the variance is given by the following expression 2.3

Var[F(k,W)]=pq (Expression 2.3)

Here, by substituting Expression 1 into Expression 2.2, Expression 3 is obtained.

$$Var [ F ( t , W ) ] = \frac{Wf ( t ) [ 1 - Wf ( t ) ]}{N} = \frac{W}{N} f ( t ) [ 1 - Wf ( t ) ] \qquad ( Expression 3 )$$

Expression 3 can be transformed into Expression 4.

$${Wf}^{2} ( t ) - f ( t ) + \frac{N}{W} Var [ F ( t , W ) ] = 0 \qquad ( Expression 4 )$$

Expression 4 can be solved as a quadratic equation of f(t) as follows.

$$f ( t ) = \frac{1}{2 W} \{ 1 \pm \sqrt{4 N Var [ F ( t , W ) ]} \} \qquad ( Expression 5.1 )$$

From Expression 5.1, the solution of Expression 4 is given by the two solutions f₊(t), f₋(t) shown as Expression 5.2.

$$\begin{matrix}{f}_{+} ( t ) = \frac{1}{2 W} \{ 1 - \sqrt{4 N Var [ F ( t , W ) ]} \} \\ ≅ \frac{1}{2 W} \{ 1 - ( 1 - \frac{4 N}{2} Var [ F ( t , W ) ] ) \} \\ = \frac{N}{W} Var [ F ( t , W ) ]\end{matrix} \\ \begin{matrix}{f}_{-} ( t ) = \frac{1}{2 W} \{ 1 + \sqrt{4 N Var [ F ( t , W ) ]} \} \\ ≅ \frac{1}{2 W} \{ 1 + ( 1 - \frac{4 N}{2} Var [ F ( t , W ) ] ) \} \\ = \frac{N}{W} \{ \frac{1}{N} - Var [ F ( t , W ) ] \}\end{matrix} \qquad ( Expression 5.2 )$$

Generally, the PDF is given by Expression 6.

f(t)=c₁f₊(t)+c₂f(t)+c₀ (Expression 6)

Note that c₁ and c₂ are respectively 1 or 0. c₀ represents an offset.

The probability density function calculating section 110 calculates the output PDF based on Expression 6. Specifically, the probability density function calculating section 110 calculates the output PDF using f₊(t) and f₋(t). As shown in Expression 5.2, f₊(t) is calculated from the variance Var [F (t,W)] of the cumulative probability distribution function of a positive sign, and f₋(t) is calculated from the variance −Var [F (t,W)] of the cumulative probability distribution function of a negative sign. Hereinafter, f₊(t) and f₋(t) are referred to as a positive probability density function and a negative probability density function.

c₁ and c₂ in Expression 6 can be determined depending on the type of the main component of the output PDF to be calculated. When the output PDF contains a plurality of components, the main component may be the one having the largest ratio of area in the PDF.

For example, when the main component of the output PDF is a uniformly distributed component, (c₁, c₂)=(1,1). When the main component of the output PDF is a sine wave component, (c₁, c₂)=(0,1). When the main component of the output PDF is a Gaussian component, (c₁, c₂)=(1,0). The main component of the output PDF is the same as the main component of the measured PDF directly generated from the measured data. The probability density function calculating section 110 may determine the main component of the output PDF based on the shape of the measured PDF.

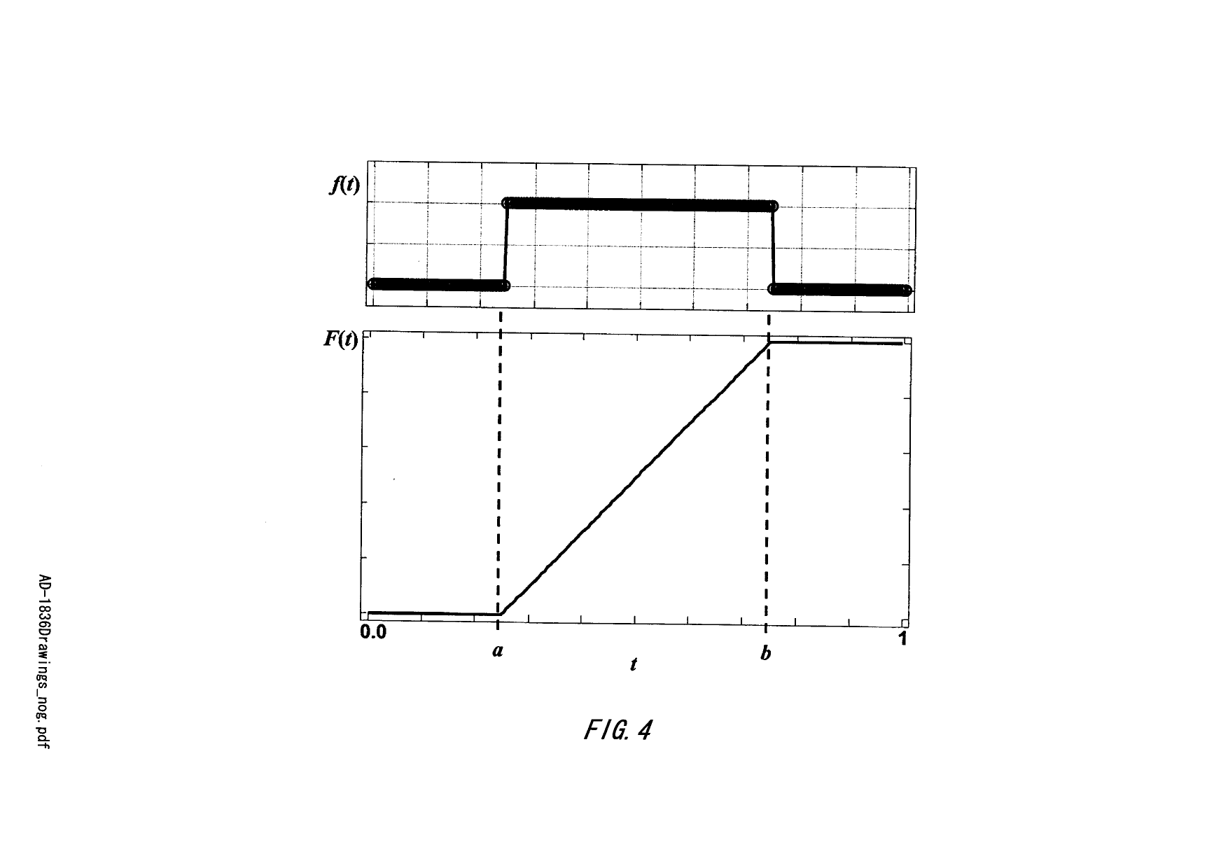

FIG. 4 shows the theoretical values of a uniformly distributed PDF and the corresponding CDF. The plot of round marks shown in the upper half of FIG. 4 represents the output PDF calculated by the probability density function calculating section 110 from the input CDF shown in the lower half of FIG. 4 based on Expression 10 explained later.

Generally, when the PDF is uniformly distributed, the theoretical values of the PDF and the corresponding CDF are given by Expression 7.

$$F ( t ) = \{ \begin{matrix}0 & t < a \\ \frac{t - a}{b - a} & a \leq t \leq b \\ 1 & t > b\end{matrix} \\ f ( t ) = \{ \begin{matrix}\frac{1}{b - a} & a \leq t \leq b \\ 0 & otherwise\end{matrix} \qquad ( Expression 7 )$$

Note that “a” represents the position of the rising edge of the uniform distribution and “b” represents the position of the falling edge of the uniform distribution.

Therefore, the “p” and “q” of Expression 2.3 are given by Expression 8.

$$\begin{matrix}p = \frac{t - a}{b - a} & a \leq t \leq b \\ q = \frac{b - t}{b - a} & a \leq t \leq b\end{matrix} \qquad ( Expression 8 )$$

In this case, the variances of a negative sign and a positive sign Var [F(t,W)] are given by Expression 9, based on Expression 2.3 and Expression 8.

$$Var [ F ( t , W ) ] = p \cdot q = \frac{- 1}{{( b - a )}^{2}} \{ {t}^{2} - ( b + a ) t + ab \} - Var [ F ( t , W ) ] = - p \cdot q = \frac{1}{{( b - a )}^{2}} \{ {t}^{2} - ( b + a ) t + ab \} \qquad ( Expression 9 )$$

By substituting Expression 9 into Expression 5.2, f₊(t), f₋(t) can be calculated.

As explained above, for a uniform distribution PDF, c₁ and c₂ in Expression 6 are both 1, and so f(t) can be given by Expression 10.

f(t)=f₊(t)+f₋(t)+c₀ (Expression 10)

As is clear from FIG. 4, f(t) calculated based on Expression 10 matches the theoretical value of f(t) well.

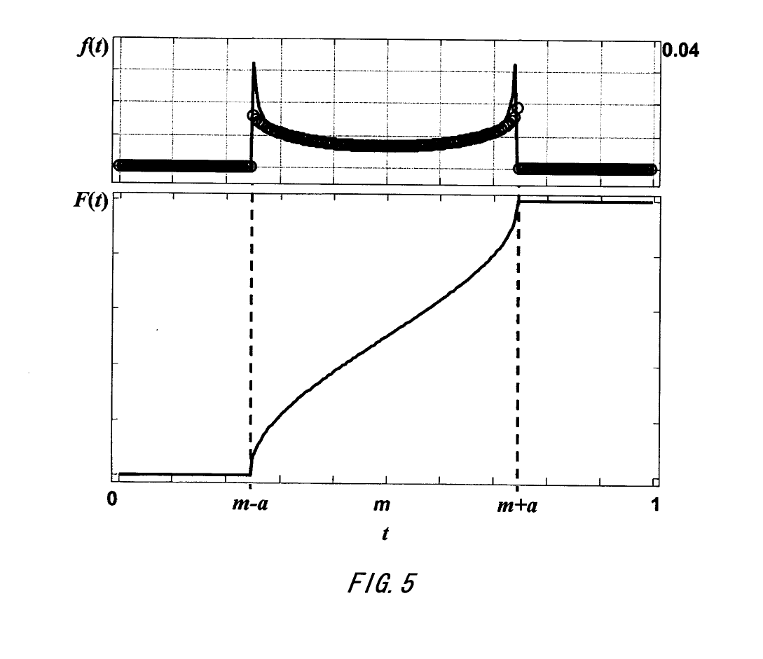

FIG. 5 shows the theoretical values of a PDF having a sine curve distribution and the corresponding CDF. The plot of round marks shown in the upper half of FIG. 5 represents the output PDF calculated by the probability density function calculating section 110 from the input CDF shown in the lower half of FIG. 5 based on Expression 14 explained later.

Generally, when the PDF has a sine wave distribution, the theoretical values of the PDF and the corresponding CDF are given by Expression 11.

$$F ( t ) = \{ \begin{matrix}0 & t < m - a \\ \frac{1}{2} + \frac{1}{π} {sin}^{- 1} \frac{t}{a} & m - a \leq t \leq m + a \\ 0 & t > m + a\end{matrix} \\ f ( t ) = \{ \begin{matrix}\frac{1}{π \sqrt{{a}^{2} - {t}^{2}}} & m - a \leq t \leq m + a \\ 0 & otherwise\end{matrix} \qquad ( Expression 11 )$$

Here, note that “m-a” represents the position of the rising edge of the sine wave distribution in the PDF, and “m+a” represents the position of the falling edge of the sine wave distribution.

Therefore, the “p” and “q” of Expression 2.3 are given by Expression 12.

$$\begin{matrix}p = \frac{1}{2} + \frac{1}{π} {sin}^{- 1} \frac{t}{a} & m - a \leq t \leq m + a \\ q = \frac{1}{2} - \frac{1}{π} {sin}^{- 1} \frac{t}{a} & m - a \leq t \leq m + a\end{matrix} \qquad ( Expression 12 )$$

In this case, the variance of a negative sign −Var[F(t,W)] is given by Expression 13.

$$- Var [ F ( t , W ) ] = - p \cdot q = \frac{1}{4} - \frac{1}{{π}^{2}} {( {sin}^{- 1} \frac{t}{a} )}^{2} \qquad ( Expression 13 )$$

By substituting Expression 13 into Expression 5.2, f₋(t) can be calculated.

As already mentioned, Expression 6 can be transformed into Expression 14, when the PDF is distributed as a sine wave.

f(t)=f₋(t)+c₀ (Expression 14)

As is clear from FIG. 5, the output PDF calculated based on Expression 14 matches well the theoretical value of the PDF shown in FIG. 5.

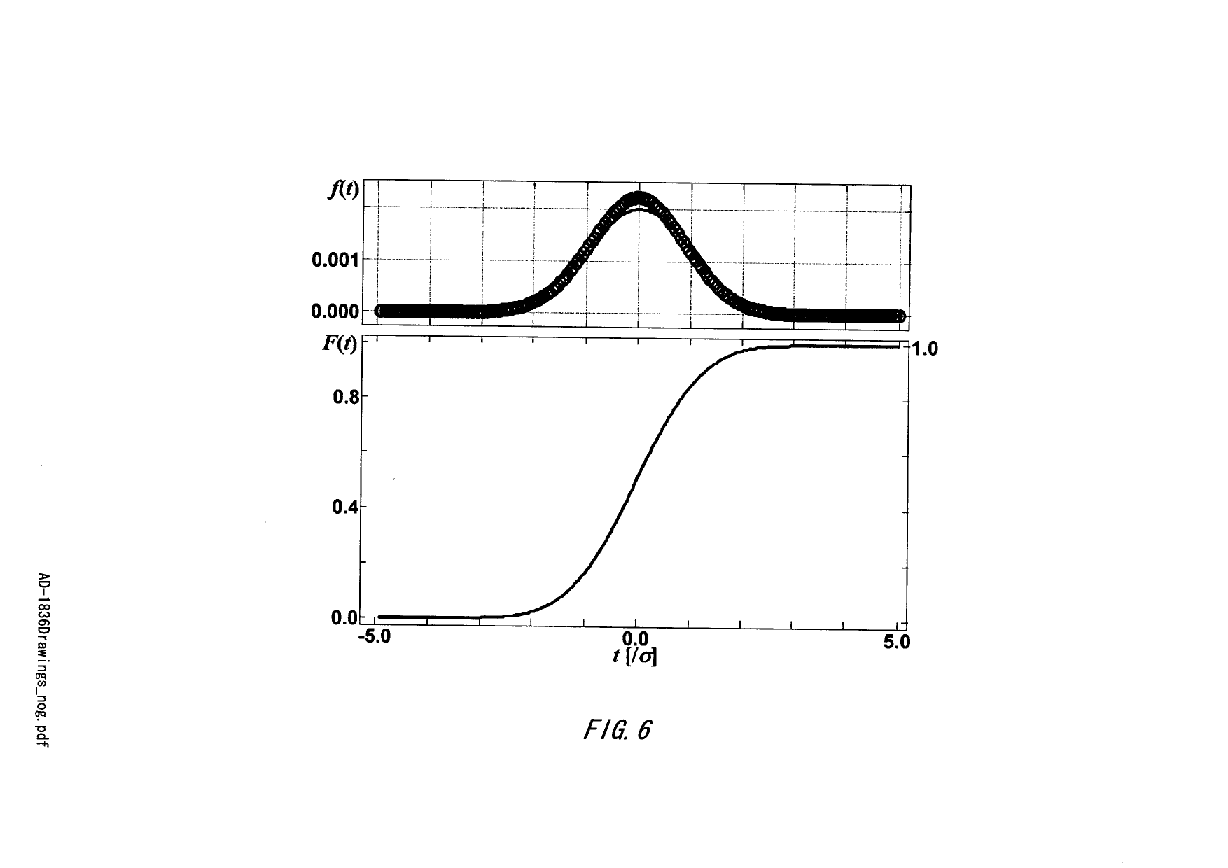

FIG. 6 shows the theoretical values of a PDF having a Gaussian distribution and the corresponding CDF. The plot of round marks shown in the PDF of the upper half of FIG. 6 represents the output PDF calculated by the probability density function calculating section 110 from the input CDF shown in the lower half of FIG. 6 based on Expression 18 explained later.

Generally, when the PDF has a Gaussian distribution, the PDF and the corresponding CDF are given by Expression 15.

$$F ( t ) = \frac{1}{σ \sqrt{2 π}} {\int }_{- ∞}^{t} exp [ - \frac{{( x - μ )}^{2}}{2 {σ}^{2}} ] d x \\ f ( t ) = \frac{1}{σ \sqrt{2 π}} exp [ - \frac{{( x - μ )}^{2}}{2 {σ}^{2}} ] \qquad ( Expression 15 )$$

Note that a represents the standard deviation of a Gaussian distribution, and IA represents the averaged value of the Gaussian distribution.

Therefore, the “p” and “q” of Expression 2.3 are given by Expression 16.

$$p = \frac{1}{σ \sqrt{2 π}} {\int }_{- ∞}^{t} exp [ - \frac{{( x - μ )}^{2}}{2} ] d x \\ q = \frac{1}{σ \sqrt{2 π}} {\int }_{t}^{∞} exp [ - \frac{{( x - μ )}^{2}}{2 {σ}^{2}} ] d x \qquad ( Expression 16 )$$

In this case, the variance of a positive sign Var [F(t,W)] is given by Expression 17, based on Expression 2.3 and Expression 16.

$$Var [ F ( t , W ) ] = \frac{1}{2 {πσ}^{2}} {\int }_{- ∞}^{t} exp [ - \frac{{( x - μ )}^{2}}{2 {σ}^{2}} ] d x {\int }_{t}^{∞} exp [ - \frac{{( x - μ )}^{2}}{2 {σ}^{2}} ] d x \qquad ( Expression 17 )$$

By substituting Expression 17 into Expression 5.2, f₊(t) can be calculated.

As already mentioned, Expression 6 can be transformed into Expression 18, when the PDF has a Gaussian distribution.

f(t)=f₊(t) (Expression 18)

As is clear from FIG. 6, the output PDF calculated based on Expression 18 matches well the theoretical value of the PDF shown in FIG. 6.

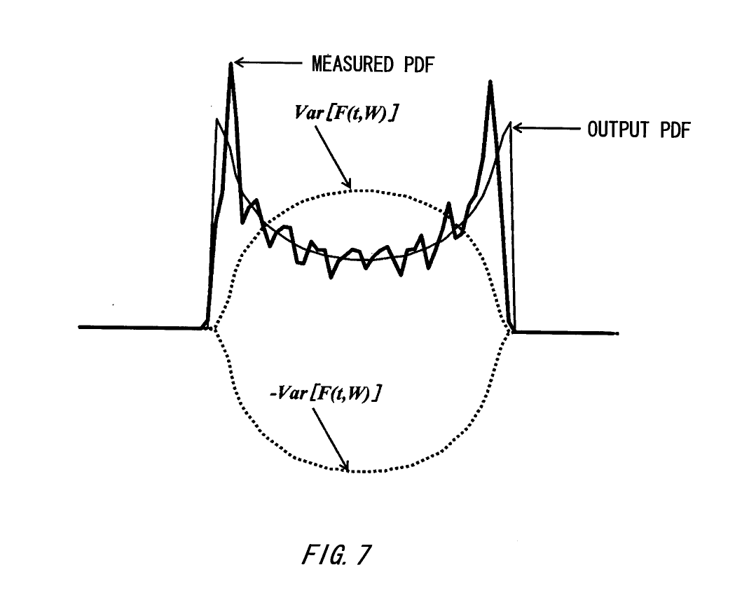

FIG. 7 explains an exemplary operation of the probability density function calculating section 110. First, the probability density function calculating section 110 determines the type of the main component contained in the PDF, based on the measured PDF. For example, the probability density function calculating section 110 can determine that the main component has a sine wave distribution, when the both ends of the measured PDF are larger than the center by a pre-set value or more. Here, the both ends of the measured PDF indicate the neighborhood of the rising edge and the falling edge of the measured PDF. When the center of the measured PDF is larger than the both ends than a pre-set value or more, the probability density function calculating section 110 may determine that the main component has a Gaussian distribution. When the level difference between the both ends and the center of the measured PDF is within a pre-set range, the probability density function calculating section 110 may determine that the main component has a uniform distribution. Note that the PDF of FIG. 7 has a main component distributed as a sine wave.

Based on the determined type of the main component, the probability density function calculating section 110 selects which one of Expressions 10, 14 and 18 is to be used in calculating the output PDF. In this example, Expression 14 is selected. Since Expression 14 uses a negative probability density function f₋(t), the output PDF is calculated based on −Var [F (t,W)] shown in FIG. 7.

When using the negative probability density function, the probability density function calculating section 110 calculates the offset to be added to the negative probability density function. When the main component of the PDF has a sine wave distribution, the offset may be determined so that the value of the negative probability density function to which the offset has been added matches the value of the measured PDF in the central bin. Here, the probability density function calculating section 110 may smooth out the measured PDF, before comparing it with the output PDF.

In addition, the probability density function calculating section 110 normalizes the value of the probability density in each bin of the negative probability density function to which the offset has been added, so that the negative probability density function to which the offset has been added has a pre-set area. Here, the pre-set area may be 1. In other words, the probability density function calculating section 110 normalizes the probability density function so that the integral value of the probability density becomes the probability of 1.

When the main component of the PDF has a uniform distribution, the offset to be added to the negative probability density function may be determined so that the value of the negative probability density function be 0 in the central bin. The probability density function calculating section 110 normalizes the value of the probability density in each bin of the probability density function so that the area of the probability density function further provided with the positive probability density function to which the offset being the same as that of the negative probability density function to which the offset has been added becomes a pre-set area.

When the main component of the PDF has a Gaussian distribution, the probability density function calculating section 110 normalizes the value of the probability density in each bin of the positive probability density function so that the positive probability density function has a pre-set area. The above-described processing enables the probability density function calculating section 110 to calculate the output PDF.

Note that the probability density function calculating section 110 may use, instead of the measured PDF, a reference probability density function calculated based on the difference in cumulative probability distribution function between random variable values of the input CDF.

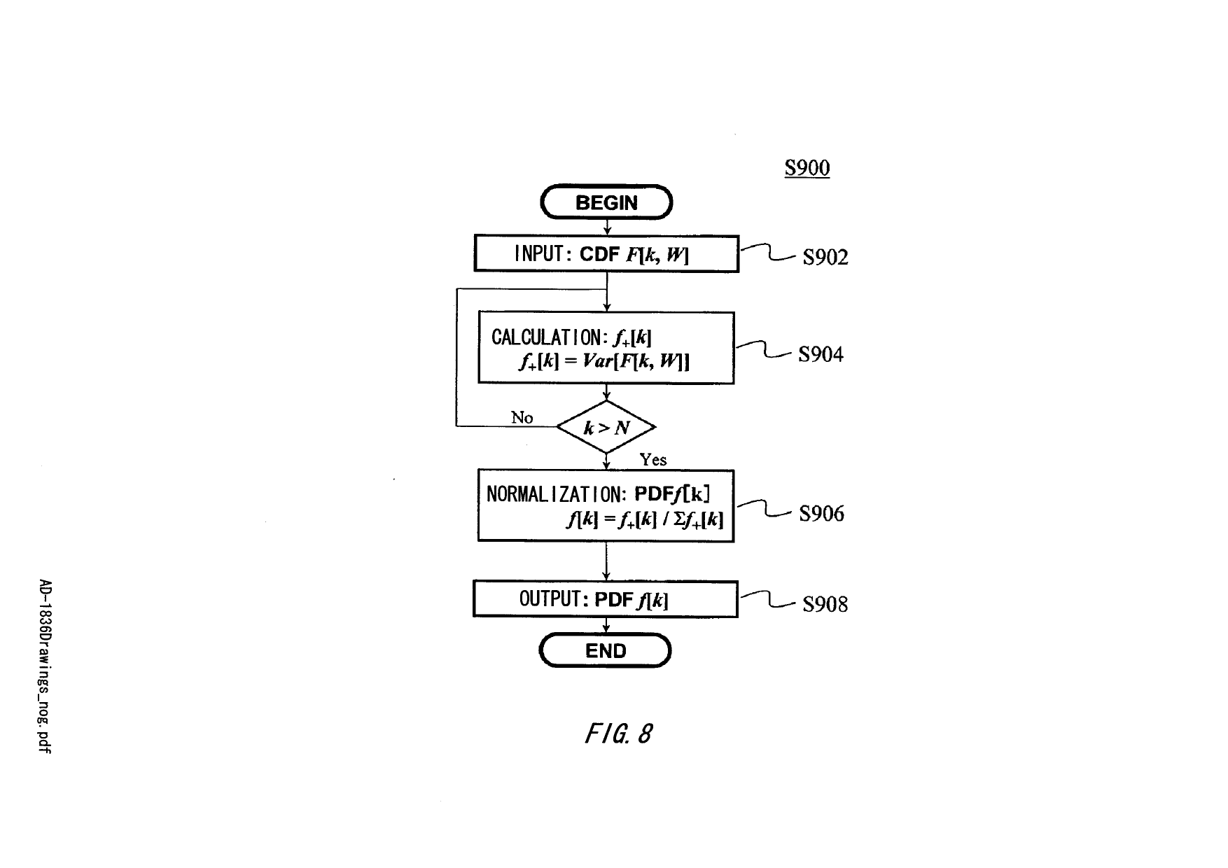

FIG. 8 shows a processing flow S900 of the probability density function calculating section 110, when calculating the output PDF using the positive probability density function. The probability density function calculating section 110 receives the input CDF in S902. Next, in S904, the probability density function calculating section 110 calculates the value f₊(t) of the positive probability density function in each bin, based on the variance Var [F (k,W)] of the CDF in each bin. In this example, f₊(t) is calculated by setting N/W to be 1 in Expression 5.2, and normalization of the PDF is performed in S906. The processing of S904 is performed for each bin of the input CDF. Specifically, the probability density function calculating section 110 repeats the processing of S904 by incrementing the value of k until k>N. Note that the probability density function calculating section 110 may determine which of the above-explained Expressions 10, 14, and 18 should be used in calculating the output PDF, after the processing of S902. In this example, the probability density function calculating section 110 uses Expression 18.

Next, in S906, the probability density function calculating section 110 normalizes the value of the probability density in each bin for the positive probability density function. The probability density function calculating section 110 may normalize the value in each bin, by dividing the value of the probability density in each bin of the positive probability density function by the summation of the values of the probability densities in all the bins of the positive probability density function. In the processing of S908, the probability density function calculating section 110 outputs the normalized positive probability density function, as the output PDF.

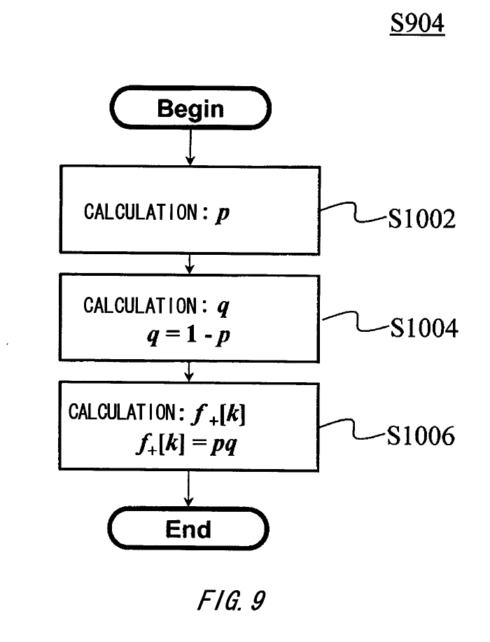

FIG. 9 shows an exemplary processing flow of S904. In this example, the probability density function calculating section 110 calculates “p” in Expression 2.3 for each bin (S1002). Next, the probability density function calculating section 110 calculates “q” in Expression 2.3 for each bin (S1004). Subsequently, the probability density function calculating section 110 calculates the product of “p” and “q” for each bin, thereby calculating the positive probability density function (S1006).

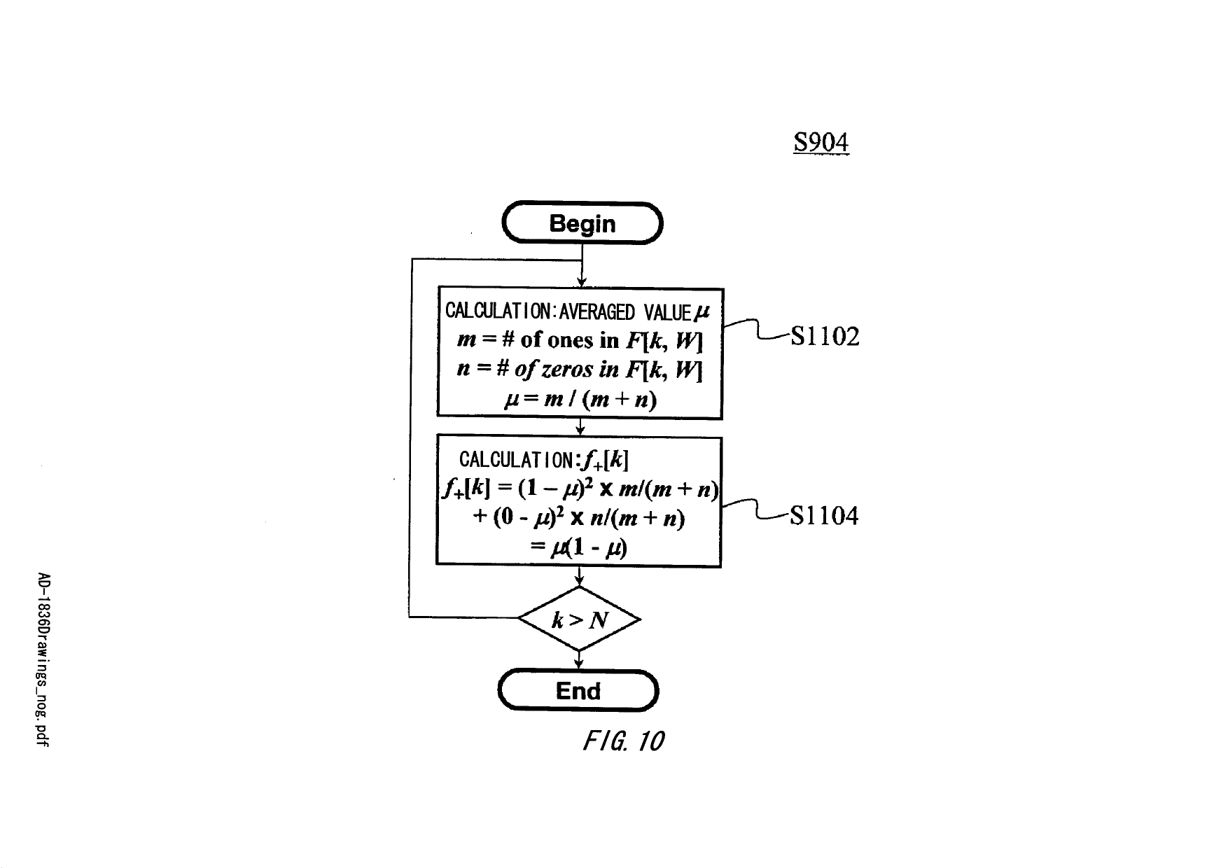

FIG. 10 shows another exemplary processing flow of S904. In this example, the probability density function calculating section 110 calculates the averaged value IA of the input CDF in each bin (S1102). For the sake of simplicity of the description, FIG. 10 shows the expression for the averaged value μ when the random variable is a two-term random variable. Note that in this example, “1” represents a case where a certain phenomenon has been caused in each bin, and “0” represents a case where no such phenomenon has been caused. In this example, the cumulative probability distribution in each bin of the input CDF is represented by “m” being the cumulative number of occurrences of “1” and “n” being the cumulative number of occurrences of “0.” In this case, the averaged value μ in each bin is given by m/(m+n).

Next, the probability density function calculating section 110 calculates the variance in each bin based on the averaged value μ (S1104). In this example, the variance in each bin is expressed as μ(1−μ).

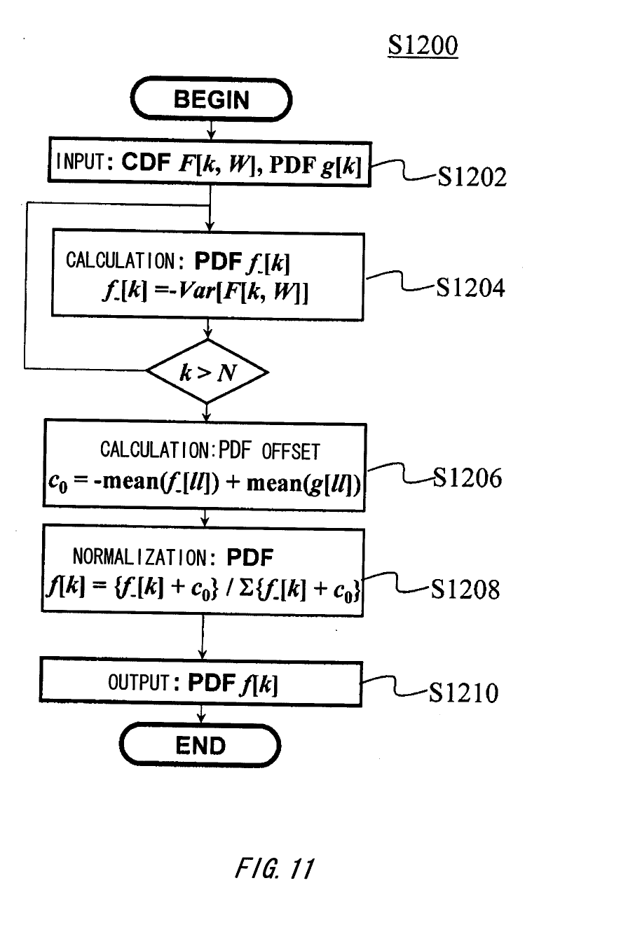

FIG. 11 shows a processing flow S1200 of the probability density function calculating section 110, when calculating the output PDF using the negative probability density function. The probability density function calculating section 110 receives the input CDF and the measured PDF in S1202. Next, in S1204, the probability density function calculating section 110 calculates the value f₋(t) of the negative probability density function in each bin, based on the variance −Var [F (k,W)] of the CDF in each bin. In this example, f₋(t) is calculated by setting N/W to be 1 and 1/N to be 0 in Expression 5.2, and addition of an offset and normalization of the PDF are performed in S1208. The processing of S1204 is performed for each bin of the input CDF. Specifically, the probability density function calculating section 110 repeats the processing of S1204 by incrementing the value of k until k>N. Note that the probability density function calculating section 110 may determine which of the above-explained Expressions 10, 14, and 18 should be used in calculating the output PDF, after the processing of S1202. In this example, the probability density function calculating section 110 uses Expression 14.

Next, in S1206, the probability density function calculating section 110 calculates the offset c₀ to be added to the negative probability density function. In this example, the probability density function calculating section 110 calculates the offset d₀ based on the difference between the averaged value in a pre-set bin range of the measured PDF and the averaged value in the pre-set bin range of the negative probability density function. The bin range may be the range from “m−a” to “m+a” shown in FIG. 5, or may even be a narrower range. For example, the bin range may be a pre-set range in the vicinity of the central bin “m”.

Next, the probability density function calculating section 110 adds the offset to the negative probability density function, and then normalizes it (S1208). The probability density function calculating section 110 may normalize the value in each bin, by dividing the value of the negative probability density function to which the offset has been added in each bin by the summation of the values of the negative probability density function to which the offset has been added in all the bins. In S1210, the probability density function calculating section 110 outputs the normalized negative probability density function, as the output PDF.

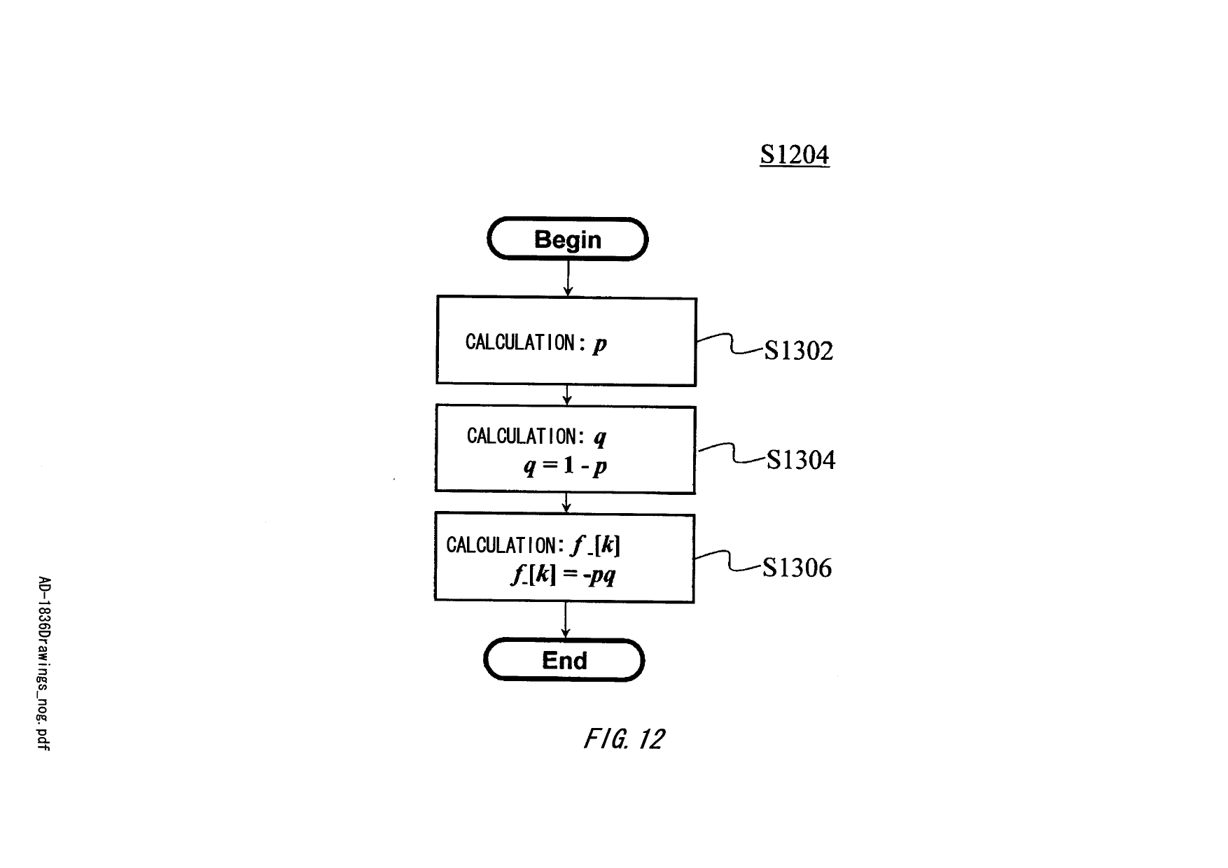

FIG. 12 shows an exemplary processing flow of S1204. The processing performed in this example is the same as the processing explained with reference to FIG. 9, except that the probability density function calculating section 110 calculates the variance in each bin based on −pq in S1306.

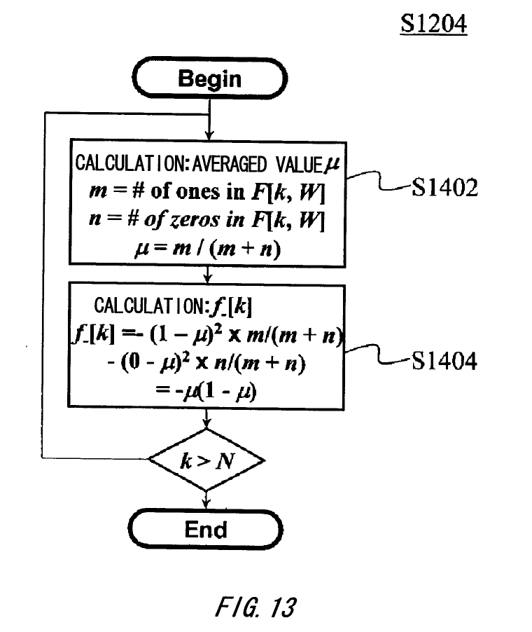

FIG. 13 shows another exemplary processing flow of S1204. The processing performed in this example is the same as the processing explained with reference to FIG. 10, except that the probability density function calculating section 110 calculates the variance in each bin based on −μ(1−μ) in S1404.

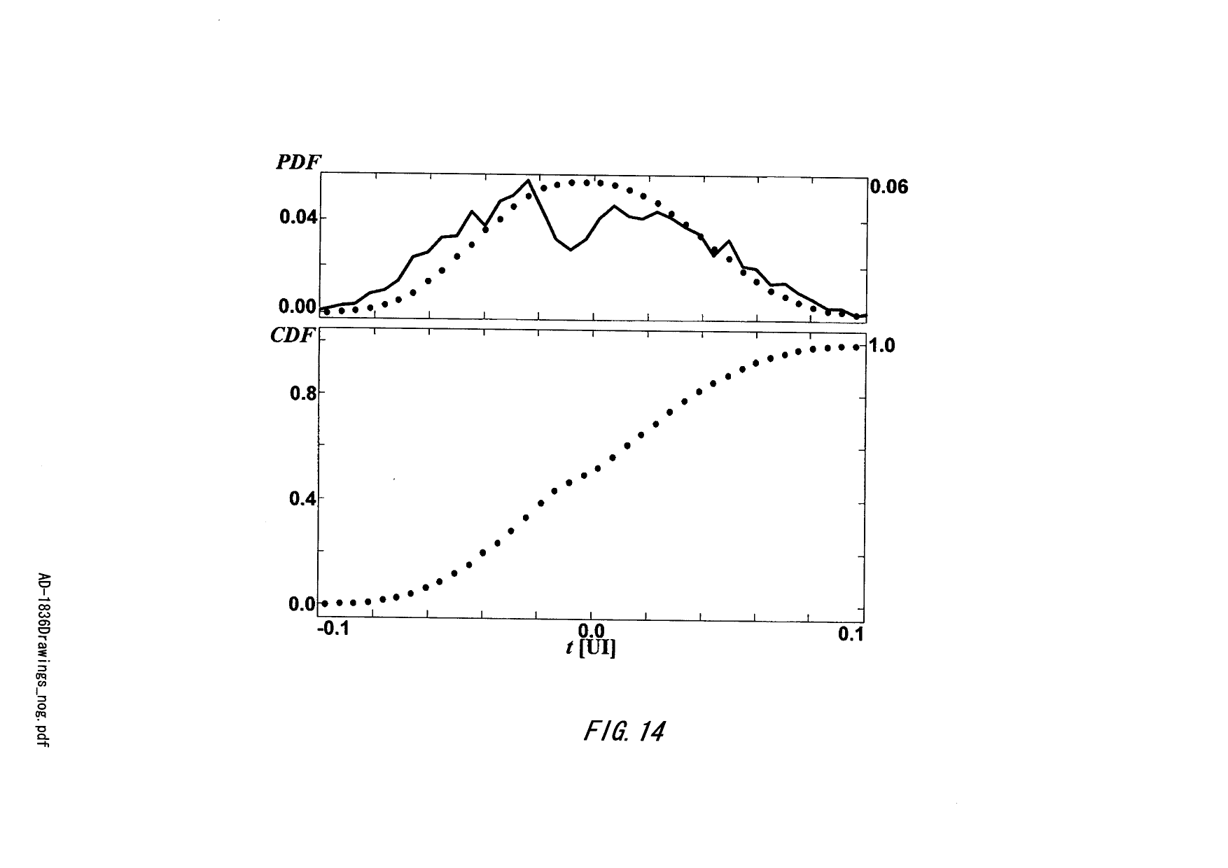

FIG. 14 shows comparison between the output PDF calculated by the probability density function calculating section 110 and the measured PDF. In FIG. 14, the PDF shown by the plot of the solid line represents the measured PDF, and the plot of round marks represents the output PDF. As is clear from FIG. 14, the effect of the variance in each bin is removed from the output PDF.

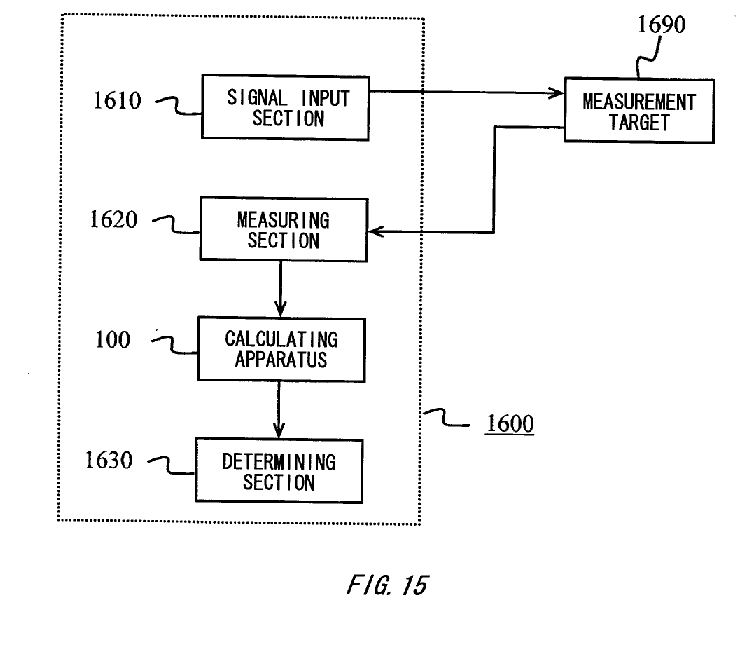

FIG. 15 shows a configuration example of a measuring apparatus 1600. The measuring apparatus 1600 measures a pre-set characteristic of the measurement target 1690, such as an electronic device, an AD converter, or the like. The measuring apparatus 1600 includes a measuring section 1620 and a calculating apparatus 100.

The measuring section 1620 measures a pre-set characteristic of the measurement target 1690. For example, the measuring section 1620 measures the jitter, the amplitude, or the like of the signal outputted from the measurement target 1690. The measuring section 1620 inputs the input CDF explained with reference to FIG. 2 through FIG. 14, to the calculating apparatus 100. The measuring section 1620 may also input the measured PDF to the calculating apparatus 100. The measuring section 1620 may include therein a measuring instrument such as an oscilloscope for directly measuring the PDF. In such a case, the measuring section 1620 may generate the input CDF by cumulating the probability density function values in each bin of the PDF measured by the oscilloscope or the like.

The calculating apparatus 100 calculates the probability density function of the pre-set characteristic of the measurement target 1690, from the measurement result of the measuring section 1620. The calculating apparatus 100 calculates the output PDF explained with reference to FIG. 2 through FIG. 14, from the input CDF supplied from the measuring section 1620. The calculating apparatus 100 may calculate the output PDF further based on the measured PDF supplied from the measuring section 1620.

The measuring apparatus 1600 may further include a signal input section 1610. The signal input section 1610 outputs an input signal for operating the measurement target 1690. For example, the signal input section 1610 outputs an input signal having a pre-set logic pattern.

The measuring apparatus 1600 may further include a determining section 1630. The determining section 1630 may determine acceptability of the measurement target 1690 to se whether it is good or bad, based on the measurement result of the measuring section 1620 or the output PDF and the output CDF calculated by the calculating section 100. In such a case, the measuring section 1600 functions as a test apparatus of the measurement target 1690.

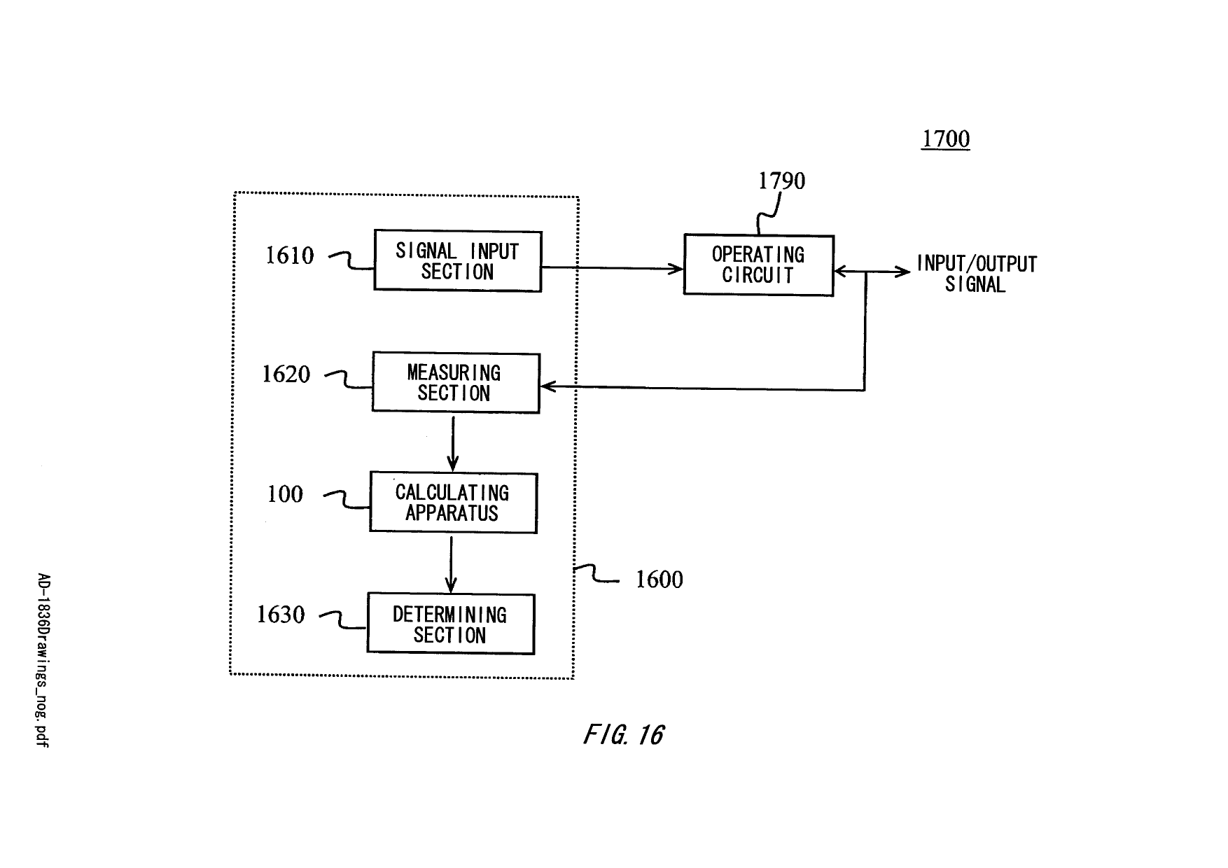

FIG. 16 shows a configuration example of an electronic device 1700. The electronic device 1700 includes a measuring apparatus 1600. The measuring apparatus 1600 measures a CDF for a certain measurement target, generates an output PDF based on the CDF, and outputs the generated output PDF to outside. The CDF may be a fail count of a signal outputted from the electronic device 1700. The output PDF outputted from the measuring apparatus 1600 may be a digital value representing the variance of the input CDF (e.g., p(1−p)). The measuring apparatus 1600 has the function and configuration that are the same as those of the measuring apparatus 1600 explained with reference to FIG. 15.

The electronic device 1700 may further include an operating circuit 1790 that operates according to a received signal, and outputs a signal in accordance with the operation result. In this case, the measuring apparatus 1600 may be a BIST circuit that measures a certain characteristic of the operating circuit 1790. The signal input section 1610 may input an input signal to the operating circuit 1790, and the measuring section 1620 measures the output signal outputted from the operating circuit 1790.

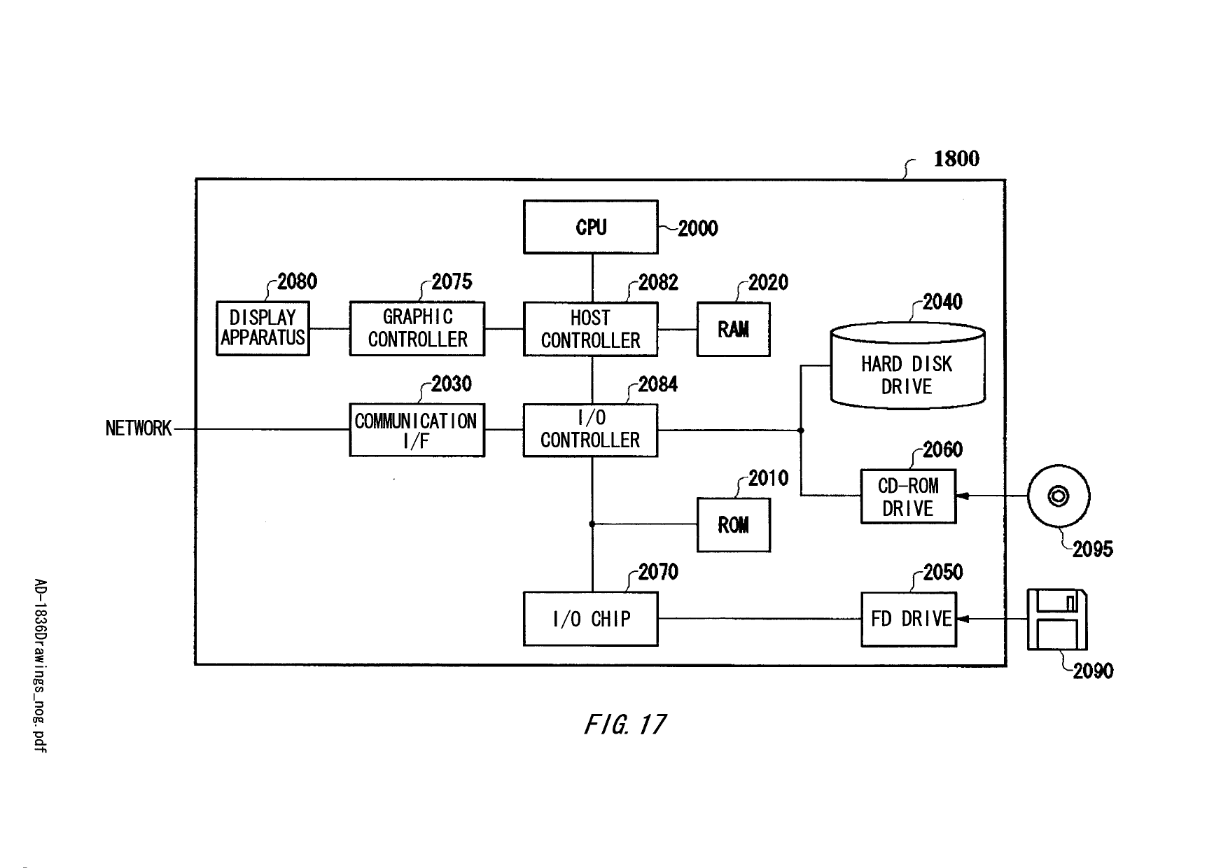

FIG. 17 illustrates an exemplary hardware configuration of a computer 1800. The computer 1800 relating to the present embodiment is constituted by a CPU surrounding section, an input/output (I/O) section and a legacy I/O section. The CPU surrounding section includes a CPU 2000, a RAM 2020, a graphic controller 2075 and a display device 2080 which are connected to each other by means of a host controller 2082. The I/O section includes a communication interface 2030, a hard disk drive 2040, and a CD-ROM drive 2060 which are connected to the host controller 2082 by means of an I/O controller 2084. The legacy I/O section includes a ROM 2010, a flexible disk drive 2050, and an I/O chip 2070 which are connected to the I/O controller 2084.

The host controller 2082 connects the RAM 2020 with the CPU 2000 and graphic controller 2075 which access the RAM 2020 at a high transfer rate. The CPU 2000 operates in accordance with programs stored on the ROM 2010 and RAM 2020, to control the constituents. The graphic controller 2075 obtains image data which is generated by the CPU 2000 or the like on a frame buffer provided within the RAM 2020, and causes the display device 2080 to display the obtained image data. Alternatively, the graphic controller 2075 may include therein a frame buffer for storing thereon the image data generated by the CPU 2000 or the like.

The I/O controller 2084 connects, to the host controller 2082, the hard disk drive 2040, communication interface 2030 and CD-ROM drive 2060 which are I/O devices operating at a relatively high rate. The communication interface 2030 communicates with different apparatuses via the network. The hard disk drive 2040 stores thereon programs and data to be used by the CPU 2000 in the computer 1800. The CD-ROM drive 2060 reads programs or data from a CD-ROM 2095, and supplies the read programs or data to the hard disk drive 2040 via the RAM 2020.

The I/O controller 2084 is also connected to the ROM 2010, flexible disk drive 2050 and I/O chip 2070 which are I/O devices operating at a relatively low rate. The ROM 2010 stores thereon a boot program executed by the computer 1800 at the startup and/or programs and the like dependent on the hardware of the computer 1800. The flexible disk drive 2050 reads programs or data from a flexible disk 2090, and supplies the read programs or data to the hard disk drive 2040 via the RAM 2020. The I/O chip 2070 is used to connect the flexible disk drive 2050 to the I/O controller 2084, and used to connect a variety of I/O devices to the I/O controller 2084, via a parallel port, a serial port, a keyboard port, a mouse port or the like.

The programs to be provided to the hard disk drive 2040 via the RAM 2020 are provided by a user in the state of being stored on a recording medium such as the flexible disk 2090, the CD-ROM 2095, and an IC card. The programs are read from the recording medium, and the read programs are installed in the hard disk drive 2040 in the computer 1800 via the RAM 2020, to be executed by the CPU 2000.

The programs that are installed in the computer 1800 and configure the computer 1800 to function as the calculating apparatus 100 includes a probability density calculating module and a cumulative probability distribution function calculating module. These programs or modules request the CPU 2000 and the like to cause the computer 1800 to function as a probability density function calculating section 110 and a cumulative probability distribution function calculating section 120, respectively.

When read by the computer 1800, the information processing described in these programs functions as a probability density function calculating section 110 and a cumulative probability distribution function calculating section 120, which are concrete means realized as a result of cooperation between the software and the above-described variety of hardware resources. The concrete means performs operations on or manipulates information according to the intended use of the computer 1800 relating to the present embodiment, thereby implementing the calculating apparatus 100 dedicated to the intended use.

For example, when the computer 1800 desired to communicate with an external apparatus or the like, the CPU 2000 executes the communication program loaded onto the RAM 2020 and instructs the communication interface 2030 to perform communication based on the processing described in the communication program. Under the control of the CPU 2000, the communication interface 2030 reads transmission data stored in a transmission buffer region or the like on a storage apparatus such as the RAM 2020, the hard disk drive 2040, the flexible disk 2090, or the CD-ROM 2095 and transmits the read transmission data to the network, or writes reception data received from the network onto a reception buffer region or the like on the storage apparatus. In this way, the communication interface 2030 may exchange the transmission data and the reception data with the storage apparatus using the direct memory access (DMA) scheme. Alternatively, the CPU 2000 may be in charge of exchanging transmission and reception data, and, specifically speaking, read data from a data source such as the storage apparatus or the communication interface 2030 and write data into a data destination such as the communication interface 2030 or the storage apparatus.

The CPU 2000 also instructs the RAM 2020 to read all or some necessary ones of the files or databases stored on an external storage apparatus such as the hard disk drive 2040, the CD-ROM drive 2060 (CD-ROM 2095), the flexible disk drive 2050 (the flexible disk 2090) using DMA transfer or the like and performs a variety of operations on the data stored on the RAM 2020. The CPU 2000 then writes the processed data back to the external storage apparatus using DMA transfer. In such a case, the RAM 2020 has a function of temporarily storing therein the content of the external storage apparatus. Thus, in the present embodiment, the RAM 2020 and the external storage apparatus are generally referred to as a memory, a storage section, or a storage apparatus. The variety of information such as programs, data, tables, or databases used in the present embodiment are stored on such a storage apparatus and can be subjected to information processing. Here, the CPU 2000 can also retain a portion of the data stored on the RAM 2020 in a cache memory and perform reading and writing on the data stored on the cache memory. In such an embodiment, the cache memory also functions as part of the RAM 2020. Thus, in the present embodiment, the cache memory is also interchangeable with the RAM 2020, the memory and/or the storage apparatus, unless otherwise stated.

The CPU 2000 performs a variety of operations instructed by the instruction sequences of the programs on the data read from the RAM 2020 and writes the resulting data back to the RAM 2020. Here, the operations include the various logic and arithmetic operations, information processing, conditional judgment, information retrieval and permutation described in the present embodiment. For example, to make conditional judgment, the CPU 2000 compares the variety of variables described in the present embodiment with other variables or constants and judges whether the former is larger, smaller, no less than, no greater than, equal to the latter. When certain conditions are satisfied (or not satisfied), the CPU 2000 branches to a different instruction sequence or invokes a subroutine.

The CPU 2000 can search through the information stored on the files or databases stored within the storage apparatus. For example, a case is assumed where the storage apparatus stores therein a plurality of entries in each of which a value of a first attribute is associated with a value of a second attribute. The CPU 2000 searches through the entries stored in the storage apparatus to identify an entry having a value of the first attribute satisfying a designated condition, and reads the value of the second attribute stored in the identified entry. In this way, the CPU 2000 can retrieve the value of the second attribute associated with the value of the first attribute that satisfies the designated condition.

The programs or modules described above may be stored on an external recording medium. Such a recording medium is, for example, an optical recording medium such as DVD and CD, a magnet-optical recording medium such as MO, a tape medium, a semiconductor memory such as an IC card and the like, in addition to the flexible disk 2090 and CD-ROM 2095. Alternatively, the recording medium may be a storage device such as a hard disk or RAM which is provided in a server system connected to a dedicated communication network or the Internet, and the programs may be provided to the computer 1800 via the network.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

What is claimed is:

1. A calculating apparatus for calculating a probability density function representing a probability density of a pre-set random variable, from a cumulative probability distribution function representing a cumulative probability distribution of the random variable, comprising:
a probability density function calculating section that calculates the probability density of each value of the random variable of the probability density function, based only on a value of the cumulative probability distribution function corresponding to the value of the random variable, from among values of the cumulative probability distribution function corresponding to values of the random variable.

2. The calculating apparatus according to claim 1, wherein
the probability density function calculating section calculates the probability density of each value of the random variable, based on a variance of the cumulative probability distribution function for the value of the random variable.

3. The calculating apparatus according to claim 2, wherein
the probability density function calculating section calculates the variance of the cumulative probability distribution function for each value of the random variable, based on
p·(1−p)
where “p” denotes a value of the cumulative probability distribution function for each value of the random variable.

4. The calculating apparatus according to claim 2, wherein
the probability density function calculating section calculates the probability density function, by using a positive probability density function calculated from a variance of the cumulative probability distribution function having a positive sign and a negative probability density function calculated from a variance of the cumulative probability distribution function having a negative sign.

5. The calculating apparatus according to claim 2, wherein
the probability density function calculating section calculates the probability density by using a negative probability density function calculated from a variance of the cumulative probability distribution function having a negative sign, when a main component of the probability density function is a sine wave component.

6. The calculating apparatus according to claim 2, wherein
the probability density function calculating section calculates the probability density by using a positive probability density function calculated from a variance of the cumulative probability distribution function having a positive sign, when a main component of the probability density function is a Gaussian component.

7. The calculating apparatus according to claim 1, further comprising:
a cumulative probability distribution function calculating section that calculates a new cumulative probability distribution function based on the probability density function calculated by the probability density function calculating section.

8. The calculating apparatus according to claim 4, wherein
when only using the positive probability density function, the probability density function calculating section normalizes the positive probability density function so that the positive probability density function has a pre-set area.

9. The calculating apparatus according to claim 4, wherein
when only using the negative probability density function, the probability density function calculating section calculates an offset to be added to the negative probability density function, and normalizes the negative probability density function so that the negative probability density function has a pre-set area.

10. A measuring apparatus for measuring a characteristic of a measurement target, comprising:
a measuring section that measures the characteristic of the measurement target; and
a calculating apparatus according to claim 1 that calculates a probability density function of a measurement result of the measuring section.

11. An electronic device for generating a signal, comprising:
a measuring section that measures a cumulative probability distribution function representing a cumulative probability distribution of a pre-set random variable, and
a calculating apparatus according to claim 1 that calculates the probability density function based on the cumulative probability distribution function measured by the measuring section.

12. The electronic device according to claim 11, wherein
the calculating apparatus outputs, as the probability density function, a digital value representing a variance of the cumulative probability distribution function.

13. A program to cause a computer to function as a calculating apparatus according to claim 1.

14. A recording medium that stores therein a program to cause a computer to function as a calculating apparatus according to claim 1.

15. A calculating method for calculating a probability density function representing a probability density of a pre-set random variable, from a cumulative probability distribution function representing a cumulative probability distribution of the random variable, comprising:
calculating the probability density of at least one value of the random variable of the probability density function, based only on a value of the cumulative probability distribution function corresponding to the value of the random variable, from among values of the cumulative probability distribution function corresponding to values of the random variable.
